(19) United States
(12) Patent Application Publication
(10) Pub. No.: US 2007/0129212 A1
(43) Pub. Date: Jun. 7, 2007

(54) Method for controlling shift pattern

(76) Inventor: Ho Wook Lee, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,730

(22) Filed: Dec. 15, 2005

(30) Foreign Application Priority Data
Dec. 5, 2005 (KR) 10-2005-0117801

(51) Int. Cl. B60W 10/04

(52) U.S. Cl. 477/115

(57) ABSTRACT

A method is disclosed for controlling a shift pattern such that an engine brake is operated well during deceleration, and a fast response is possible for reacceleration, by maintaining a gear ratio for a predetermined time duration. A method for controlling a shift pattern according to an exemplary embodiment of the present invention includes detecting a throttle valve opening, and maintaining a current gear ratio during a predetermined time when the throttle valve is closed.

### CROSS-REFERENCE TO RELATED APPLICATION

This application claims priority to and the benefit of Korean Patent Application No. 10-2005-0117801 filed in the Korean Intellectual Property Office on Dec.05, 2005 the entire contents of which are incorporated herein by reference.

### BACKGROUND OF THE INVENTION

(a) Field of the Invention

The present invention relates to a method for controlling a shift pattern such that an engine brake operates well during deceleration, and a fast response is possible for reacceleration, by maintaining a gear ratio for a predetermined time period.

(b) Description of the Related Art

Generally, a CVT (continuously variable transmission) is designed to be operated under various operational modes, for example, sports mode, normal mode, etc.

FIG. 1 shows a gear ratio control map according to a normal mode, and FIG. 2 shows a gear ratio control map according to a sports mode. Here, VSP means a vehicle speed, and Npri means a rotation speed of a primary pulley fixedly coupled to an input shaft.

Referring to FIG. 1 and FIG. 2, the gear ratio control map according to the sports mode is set to have a higher gear ratio (lower shift speed) than that of the normal mode. Therefore, accelerating performance in the sports mode is better than in the normal mode, and a response for reacceleration at middle or high speed in the sports mode is faster than in the normal mode. That is, a response for shifting the shift speed is faster than in the normal mode.

At the beginning of driving in the sports mode, due to the higher gear ratio (lower shift speed), a fast response can be achieved. However, when the throttle valve is closed, the shift speed is up shifted (to have a lower gear ratio), and, problematically, the shift speed should be down shifted (to have a higher gear ratio) again for reacceleration. For reacceleration, an engine rpm is increased, and the shift speed should be down shifted for fast reacceleration. However, the gear ratio is not fixed at deceleration, as in a manual transmission, but response for down shifting (to have a higher gear ratio) is not sufficiently fast.

When a vehicle runs in sports mode, the operation of an engine brake is necessarily required. However, since the shift speed is down shifted (to have a higher shift speed) and the current shift speed used for accelerating is not fixed when the vehicle is being decelerated, the engine brake cannot function sufficiently well.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide a method for controlling a shift pattern having advantages of quick acceleration, quick braking, and higher engine braking performance by maintaining a gear ratio after the throttle valve is closed.

An exemplary method for controlling a shift pattern according to an embodiment of the present invention includes detecting whether a throttle valve is open and maintaining a current gear ratio during a predetermined time period when the throttle valve is closed.

A method for controlling a shift pattern may further include detecting whether a brake is operated and maintaining the current gear ratio while the brake is operated even though the predetermined time has passed.

In addition, an exemplary method may include detecting whether the throttle valve is re-opened after the throttle valve has closed and determining a gear ratio on the basis of a throttle valve open-angle when the throttle valve is re-opened. The method may further include determining a current shift mode, and said detecting is performed only when the current shift mode is a sports mode.

### BRIEF DESCRIPTION OF THE DRAWINGS

FIG. 1 is a gear ratio control map according to a normal mode.

FIG. 2 is a gear ratio control map according to a sports mode.

FIG. 3 is a flow-chart illustrating a method for controlling a shift pattern according to an exemplary embodiment of the present invention.

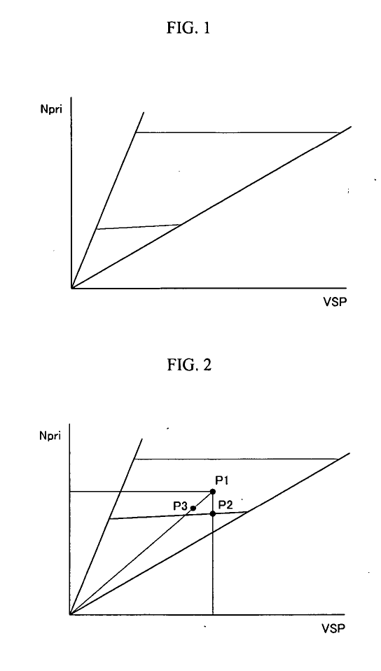

### DETAILED DESCRIPTION OF THE EMBODIMENT

An exemplary embodiment of the present invention will hereinafter be described in detail with reference to the accompanying drawings.

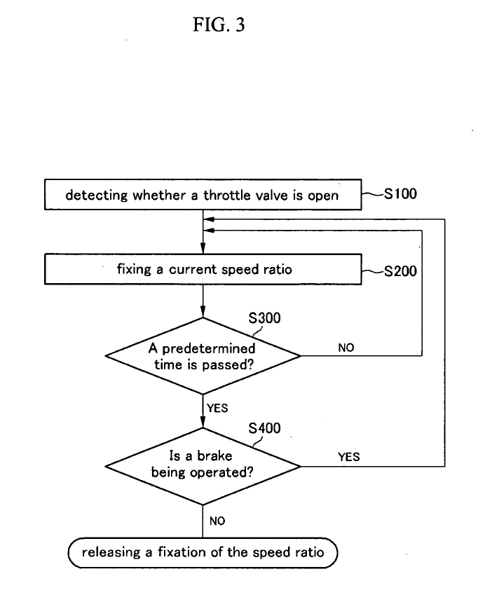

A throttle valve open-angle is detected by a TPS (throttle position sensor) at step S100, as shown in FIG. 3.

As a result of the detecting, when the throttle valve is closed, a current gear ratio is maintained at step S200. That is, the current gear ratio is fixed.

Then, it is detected whether a predetermined time has passed. As a result of detecting the time, if the predetermined time has not yet passed, the current gear ratio is maintained at step 300. However, if the predetermined time has passed, operation of a brake is detected at this step.

As a result of detecting operation of the brake, if the brake is operated, the current gear ratio is maintained at step S400. However, if the brake is not operated, fixing of the gear ratio is released at step S400.

Hereinafter, referring to FIG. 2, a control of such a shift pattern will be described in more detail.

According to the conventional method, when the throttle valve is closed while the vehicle runs in a gear ratio corresponding to a first point P1, the gear ratio is changed to the second point P2. Since the throttle valve is closed without the vehicle speed changing, the gear ratio is controlled to be changed in the direction where the Npri (rotation speed of the primary pulley) becomes lower.

However, according to an exemplary shift pattern of the present invention, the gear ratio is controlled to be changed to a third point P3, instead of P2.

Referring to FIG. 2, since P1 and P3 are on the same straight line, the gear ratios corresponding to P1 and P3 are the same. Therefore, the current gear ratio is maintained without shifting.

According to such a fixation of the gear ratio, when the throttle valve is temporarily closed after quick acceleration, fast reacceleration is enabled due to the fixed lower shift speed (to have higher gear ratio). In addition, performance of an engine brake according to the gear ratio corresponding to the third point P3 is better than the performance according to the gear ratio corresponding to the second point P2.

Therefore, quick acceleration and quick braking especially required in the sports mode can be performed. The sports mode lays more emphasis on quick acceleration and quick braking rather than on fuel consumption.

While this invention has been described in connection with what is presently considered to be the most practical exemplary embodiment, it is to be understood that the invention is not limited to the disclosed embodiment, but, on the contrary, is intended to cover various modifications and equivalent arrangements included within the spirit and scope of the appended claims.

What is claimed is:

1. A method for controlling a shift pattern, comprising:
detecting whether a throttle valve is open; and
maintaining a current gear ratio during a predetermined time period when the throttle valve is closed.

2. The method of claim 1, further comprising:
detecting whether a brake is operated while the gear ratio is maintained; and
maintaining the current gear ratio while the brake is operated even though the predetermined time has passed.

3. The method of claim 1, further comprising:
detecting whether the throttle valve is re-opened after the throttle valve is closed; and
determining a gear ratio on the basis of a throttle valve open-angle when the throttle valve is re-opened.

4. The method of claim 1, further comprising
determining whether a current shift mode is a sports mode, and said detecting is performed only when the current shift mode is a sports mode.

5. The method of claim 2, further comprising
determining whether a current shift mode is a sports mode, and said detecting is performed only when the current shift mode is a sports mode.

6. The method of claim 3, further comprising
determining whether a current shift mode is a sports mode, and said detecting is performed only when the current shift mode is a sports mode.
